(19) United States
(12) Patent Application Publication
(10) Pub. No.: US 2003/0055969 A1
(43) Pub. Date: Mar. 20, 2003

(54) System and method for performing power management on a distributed system

(75) Inventors: Ralph Murray Begun, Raleigh, NC (US); Steven Wade Hunter, Raleigh, NC (US); Darryl C. Newell, Kirkland, WA (US)

Correspondence Address: BRACEWELL & PATTERSON, L.L.P., P.O. BOX 969, AUSTIN, TX, 78767-0969, US

(73) Assignee: International Business Machines Corporation, Armonk, NY

(21) Appl. No.: 09/953,761

(22) Filed: Sep. 17, 2001

(51) Int. Cl. G06F 15/173

(52) U.S. Cl. 709/226

(57) ABSTRACT

An improved system and method for performing power management on a distributed system. The system utilized to implement the present invention includes multiple servers for processing a set of tasks. The method of performing power management on a system first determines if the processing capacity of the system exceeds a predetermined workload. If the processing capacity exceeds a predetermined level, at least one of the multiple servers on the network is selected to be powered down and the tasks across the remaining servers are rebalanced. If the workload exceeds a predetermined processing capacity of the system and at least a server in a reduced power state may be powered up to a higher power state to increase the overall processing capacity of the system.

### BACKGROUND OF THE INVENTION

1. Technical Field

The present invention relates in general to the field of data processing systems, and more particularly, the field of power management in data processing systems. Still more particularly, the present invention relates to a system and method of performing power management on networked data processing systems.

2. Description of the Related Art

A network (e.g., Internet or Local Area Network (LAN)) in which client requests are dynamically distributed among multiple interconnected computing elements is referred to as a “load sharing data processing system.” Server tasks are dynamically distributed in a load sharing system by a load balancing dispatcher, which may be implemented in software or in hardware. Clients may obtain service for requests by sending the requests to the dispatcher, which then distributes the requests to various servers that make up the distributed data processing system.

Initially, for cost-effectiveness, a distributed system may comprise a small number of computing elements. As the number of users on the network increases over time and requires services from the system, the distributed system can be scaled by adding additional computing elements to increase the processing capacity of the system. However, each of these components added to the system also increases the overall power consumption of the aggregate system.

Even though the overall power consumption of a system remains fairly constant for a given number of computing elements, the workload on the network tends to vary widely. The present invention, therefore recognizes that it would be desirable to provide a system and method of scaling the power consumption of the system to the current workload on the network.

### SUMMARY OF THE INVENTION

The present invention presents an improved system and method for performing power management for a distributed system. The distributed system utilized to implement the present invention includes multiple servers for processing tasks and a resource manager to determine the relation between the workload and the processing capacity of the system. In response to determining the relation, the resource manager determines whether or not to modify the relation between the workload and the processing capacity of the distributed system.

The method of performing power management on system first determines if the processing capacity of the system exceeds a predetermined workload. If the processing capacity exceeds the workload, at least one of the multiple servers of the system is selected to be powered down to a reduced power state. Then, tasks are redistributed across the plurality of servers. Finally, the selected server(s) is powered down to a reduced power state.

Also, the method determines if the workload exceeds a predetermined processing capacity of the system. If so, at least a server in a reduced power state may be powered up to a higher power state to increase the overall processing capacity of the system. Then, the tasks are redistributed across the servers in the system.

### BRIEF DESCRIPTION OF THE DRAWINGS

FIG. 1 illustrates an exemplary distributed system that may be utilized to implement a first preferred embodiment of the present invention;

FIG. 2 depicts a block diagram of a resource manager utilized for load balancing and power management according to a first preferred embodiment of the present invention;

FIG. 3 illustrates an exemplary distributed system that may be utilized to implement a second preferred embodiment of the present invention.

FIG. 4 depicts a block diagram of a resource manager utilized for load balancing according to a second preferred embodiment of the present invention;

FIG. 5 illustrates a connection table utilized for recording existing connections according to a second preferred embodiment of the present invention;

FIG. 6 depicts a layer diagram for the software, including a power manager, utilized to implement a second preferred embodiment of the present invention; and

FIG. 7 illustrates a high-level logic flowchart depicting a method for performing power management for a system according to both a first and second preferred embodiment of the present invention.

### DETAILED DESCRIPTION OF THE PREFERRED EMBODIMENT

The following description of the system and method of power management of the present invention utilizes the following terms:

“Input/output (I/O) utilization” can be determined by monitoring a pair of queues (or buffers) associated with one or more I/O port(s). A first queue is the receive (input) queue, which temporarily stores data awaiting processing. A second queue is the transmit (output) queue, which temporarily stores data awaiting transmission to another location. I/O utilization can also be determined by monitoring transmit control protocol (TCP) flow and/or congestion control, which indicates the conditions of the network, and/or system.

“Workload” is defined as the amount of (1) I/O utilization, (2) processor utilization, or (3) any other performance metric of servers employed to process or transmit a data set.

“Throughput” the amount of workload performed in a certain amount of time.

“Processing capacity” is the configuration-dependent maximum level of throughput.

“Reduced power state” is the designated state of a server operating at a relatively lower power mode. There may be several different reduced power states. A data processing system can be completely powered off and require a full reboot of the hardware and operating system. The main disadvantage of this state is the latency required to perform a full reboot of the system. A higher power state is a “sleep state,” in which at least some data processing system components (e.g., direct access storage device (DASD), memory, and buses) are powered down, but can be brought to full power without rebooting. Finally, the data processing system may be in a higher power “idle state,” with a frequency throttled processor, inactive DASD, but the memory remains active. This state allows the most rapid return to a full power state and is therefore employed when a server is likely to be idle for a short duration.

“Reduced power server(s)” is a server or group of servers operating in a “reduced power state.”

“Higher power state” is the designated state of a server operating at a relatively higher power than a reduced power state.

“Higher power server(s)” is a server or group of servers operating in a “higher power state.”

“Frequency throttling” is a technique for changing power consumption of a system by reducing or increasing the operational frequency of a system. For example, by reducing the operating frequency of the processor under light workload requirements, the processor (and system) employs a significantly less amount of power for operation, since power consumed is related to the power supply voltage and the operating frequency.

In one embodiment of the present invention, data processing systems communicate by sending and receiving Internet protocol (IP) data requests via a network such as the Internet. IP defines data transmission utilizing data packets (or “fragments”), which include an identification header and the actual data. At a destination data processing system, the fragments are combined to form a single data request.

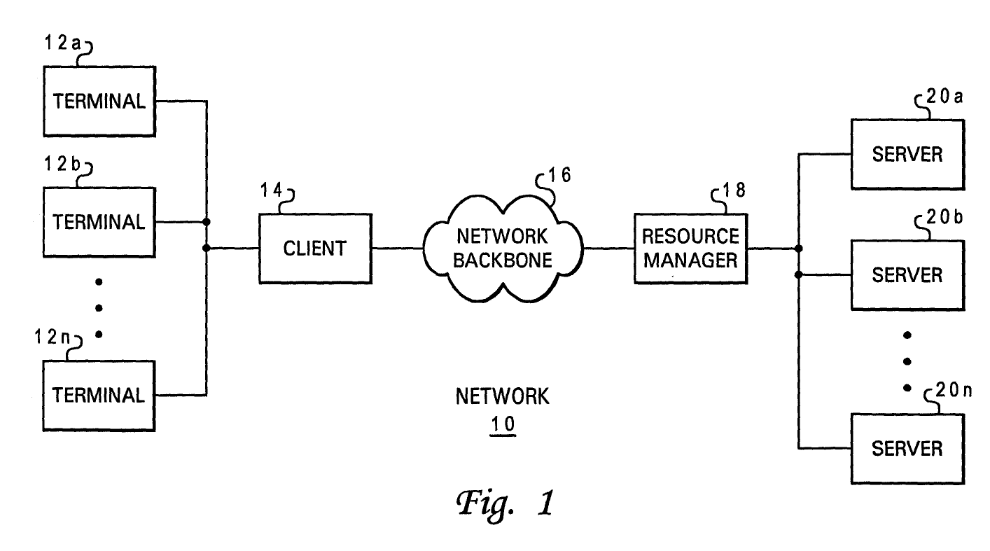

With reference now to the figures, and in particular, with reference to FIG. 1, there is depicted a block diagram of a network 10 in which a first preferred embodiment of the present invention may be implemented. Network 10 may be a local area network (LAN) or a wide area network (WAN) coupling geographically separate devices. Multiple terminals 12a-12n, which can be implemented as personal computers, enable multiple users to access and process data. Users send data requests to access and/or process remotely stored data through network backbone 16 (e.g., Internet) via a client 14.

Resource manager 18 receives the data requests (in the form of data packets) via the Internet and relays the requests to multiple servers 20a-20n. Utilizing components described below in more detail, resource manager 18 distributes the data requests among servers 20a-20n to promote (1) efficient utilization of server processing capacity and (2) power management by powering down selected servers to a reduced power state when the processing capacity of servers 20a-20n exceeds a current workload.

During operation, the reduced power state selected depends greatly on the environment of the distributed system. For example, in a power scarce environment, the system of the present invention can completely power off the unneeded servers. This implementation of the present invention may be appropriate for a power sensitive distributed system where response time is not critical.

Also, if the response time is critical to the operation of the distributed system, a full shutdown of unneeded servers and the subsequent required reboot time might be undesirable. In this case, the selected reduced power state might only be the frequency throttling of the selected unneeded server or even the “idle state.” In both cases, the reduced power servers may be quickly powered up to meet the processing demands of the data requests distributed by resource manager 18.

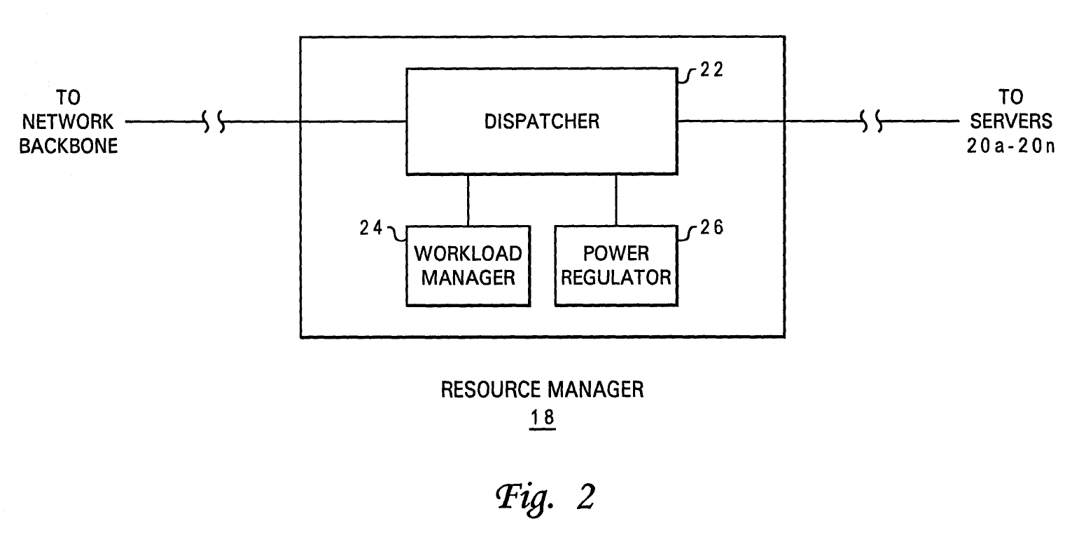

Referring to FIG. 2, there is illustrated a detailed block diagram of resource manager 18 according to a first preferred embodiment of the present invention. Resource manager 18 may comprise a dispatcher component 22 for receiving and sending data requests to and from servers 20a-20n to prevent any single higher power server's workload from exceeding the server's processing capacity.

Preferably, a workload management (WLM) component 24 determines a server's processing capacity utilizing more than one performance metric, such as utilization and processor utilization, before distributing data packets over servers 20a-20n. In certain transmission-heavy processes, five percent of the processor may be utilized, but over ninety percent of the I/O may be occupied. If WLM 24 utilized processor utilization as its sole measure of processing capacity, the transmission-heavy server may be wrongfully powered down to a reduced power state when powering up a reduced power server to rebalance the transmission load might be more appropriate. Therefore, WLM 24 or any other load balancing technology implementing the present invention preferably monitors at least (1) processor utilization, (2) I/O utilization, and (3) any other performance metric (also called a “custom metric”), which may be specified by a user.

After determining the processing capacity of servers 20a-20n, WLM 24 selects a server best suited for receiving a data packet. Dispatcher 22 distributes the incoming data packets to the selected server by (1) examining identification field of each data packet, (2) replacing the address in destination address field with an address unique to the selected server, and (3) relaying the data packet to the selected server.

Power regulator 26 operates in concert with WLM 24 by monitoring incoming and outgoing data to and from servers 20a-20n. If a higher power server remains idle (e.g., does not receive or send a data request for a predetermined interval) or available processing capacity exceeds a workload, determined by a combination of I/O utilization, processor utilization, and any other custom metric, WLM 24 selects at least one higher power server to power down to a reduced power state. If the selected reduced power state is a full power down or sleep modes, dispatcher 22 redistributes the tasks (e.g., functions to be performed by the selected higher power server) on the higher power servers selected for powering down among the remaining higher power servers and sends a signal that indicates to power regulator 26 that dispatcher 22 has completed the task redistribution. Then, power regulator 26 powers down a higher power server to a reduced power state.

If the selected reduced power state is an idle or frequency throttled state, dispatcher 22 redistributes a majority of the tasks on the higher power severs selected for powering down among the higher power servers. However, the frequency throttled server may still process tasks, but at a reduced capacity. Therefore, some tasks remain on the frequency throttled server despite its reduced power state.

If the tasks on the higher power servers exceeds the processing capacity, power regulator 26 powers up a reduced power server, if available, to a higher power state to increase the processing capacity of servers 20a-20n. Dispatcher 22 redistributes the tasks across the new set of higher power servers to take advantage of the increase processing capacity.

An advantage to this first preferred embodiment of the present invention is the more efficient power consumption of the distributed server. If the processing capacity of the system exceeds the current workload, at least one higher power server may be powered down to a reduced power state, thus decreasing the overall power consumption of the system.

One drawback to this first preferred embodiment of the present invention is the installation of resource manager 18 as a bidirectional passthrough device between the network and servers 20a-20n, which may result in a significant bottleneck in networking throughput from the servers to the network. The user of a single resource manager 18 also creates a single point of failure between the server group and the client.

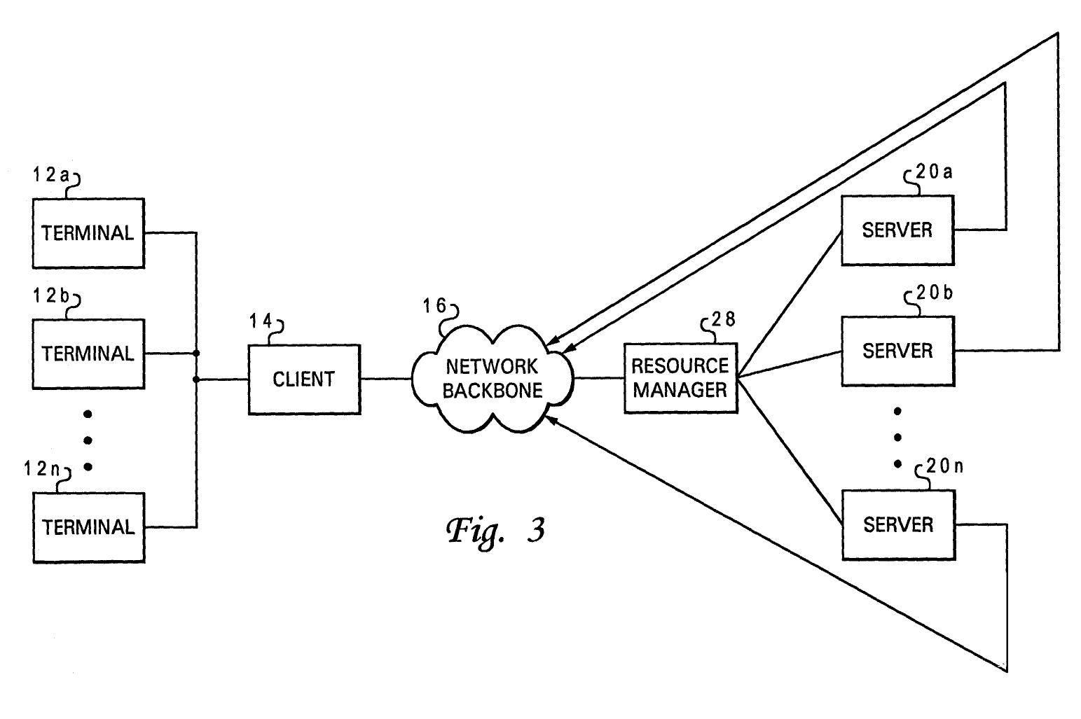

With reference to FIG. 3, there is depicted a block diagram of a network 30 in which a second preferred embodiment of the present invention may be implemented. Network 30 may also be a local area network (LAN) or a wide area network (WAN) coupling geographically separate devices. Multiple terminals 12a-12n, which can be implemented as personal computers, enable multiple users to access and process data. Users send data requests for remotely stored data through a client 14 and a network backbone 16, which may include the Internet. Resource manager 28 receives the data requests via the Internet and relays the data request to dispatcher 32, which assigns each data request to a specific server. Unlike the first preferred embodiment of the present invention, servers 20a-20n sends outgoing data packets directly to client 14 via network backbone 16, instead of sending the data packet back through dispatcher 32.

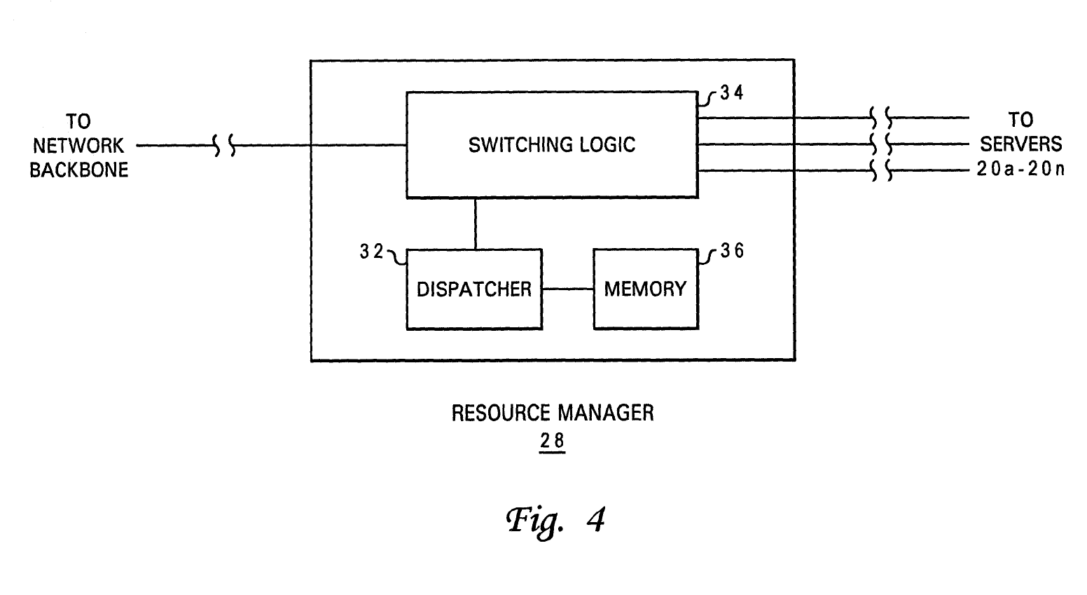

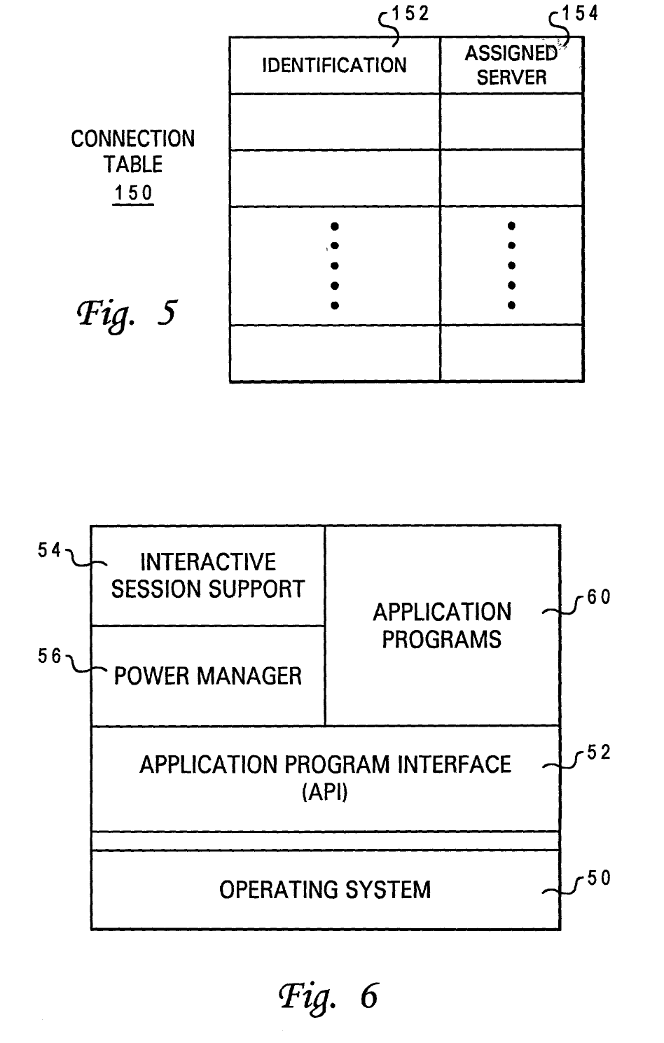

Referring to FIG. 4, there is illustrated a block diagram of resource manager 28 according to a second preferred embodiment of the present invention. Dispatcher 32, coupled to a switching logic 34, distributes tasks received from network backbone 16 to servers 20a-20n. Dispatcher 32 examines each data request identifier in each data packet identification header and compares the identifier to other identifiers listed in an identification field 152 in a connection table (as depicted in FIG. 5) stored in memory 36. Connection table 150 includes two fields: identification field 152 and a corresponding assigned server field 154. Identification field 152 lists existing connections (e.g., pending data requests) and assigned server field 154 indicates the server assigned to the existing connection. If the data request identifier from a received data packet matches another identifier listed on connection table 150, the received data packet represents an existing connection, and dispatcher 32 automatically forwards to the appropriate server the received data packet utilizing the server address in an assigned server field 154. However, if the data request identifier does not match another identifier listed on connection table 150, the data packet represents a new connection. Dispatcher 32 records the request identifier from the data packet into identification field 152, selects an appropriate server to receive the new connection (to be explained below in more detail), and records the address of the appropriate server in assigned server field 154.

With reference to FIG. 6, there is illustrated a diagram outlining an exemplary software configuration stored in servers 20a-20n according to a second preferred embodiment of the present invention. As well-known in the art, a data processing system (e.g., servers 20a-20n) requires a set of program instructions, know as an operating system, to function properly. Basic functions (e.g., saving data to a memory device or controlling the input and output of data by the user) are handled by operating system 50, which may be at least partially stored in memory and/or direct access storage device (DASD) of the data processing system. A set of application programs 60 for user is functions (e.g., an e-mail program, word processors, Internet browsers) runs on top of operating system 50. As shown, interactive session support (IS S) 54, and power manager 56 access the functionality of operating system 50 via an application program interface (API) 52.

ISS (Interactive Session Support) 54, a domain name system (DNS) based component installed on each of servers 20a-20n, implements I/O utilization, processor utilization, or any other performance metric (also called a “custom metric”) to monitor the distribution of the tasks over servers 20a-20n. Functioning as an “observer” interface that enables other applications to monitor the load distribution, ISS 54 enables program manager 56 to power up or power down servers 20a-20n as workload and processing capacities fluctuate. Dispatcher 32 also utilizes performance metric data from ISS 54 to perform load balancing functions for the system. In response to receiving a data packet representing a new connection, dispatcher 32 selects an appropriate server to assign a new connection utilizing task distribution data from ISS 54.

Power manager 56 operates in concert with dispatcher 32 via ISS 54 by monitoring incoming and outgoing data to and from servers 20a-20n. If a higher power server remains idle (e.g., does not receive or send a data request for a predetermined time) or available processing capacity exceeds a predetermined workload, as determined by ISS 54, dispatcher 32 selects a higher power server to be powered down to a reduced power state, redistributes the tasks of among the remaining higher power servers and sends a signal to power manager 56 indicating the completion of task redistribution. Power manager 56 powers down the selected higher power server to a reduced power state, in response from receiving the signal from dispatcher 32. Also, if the workload on the higher power servers exceeds the processing capacity, power manager 56 powers up a reduced power server, if available, to a higher power state to increase the processing capacity of servers 20a-20n. Dispatcher 32 then redistributes the tasks among the new set of higher power servers to take advantage of the increased processing capacity.

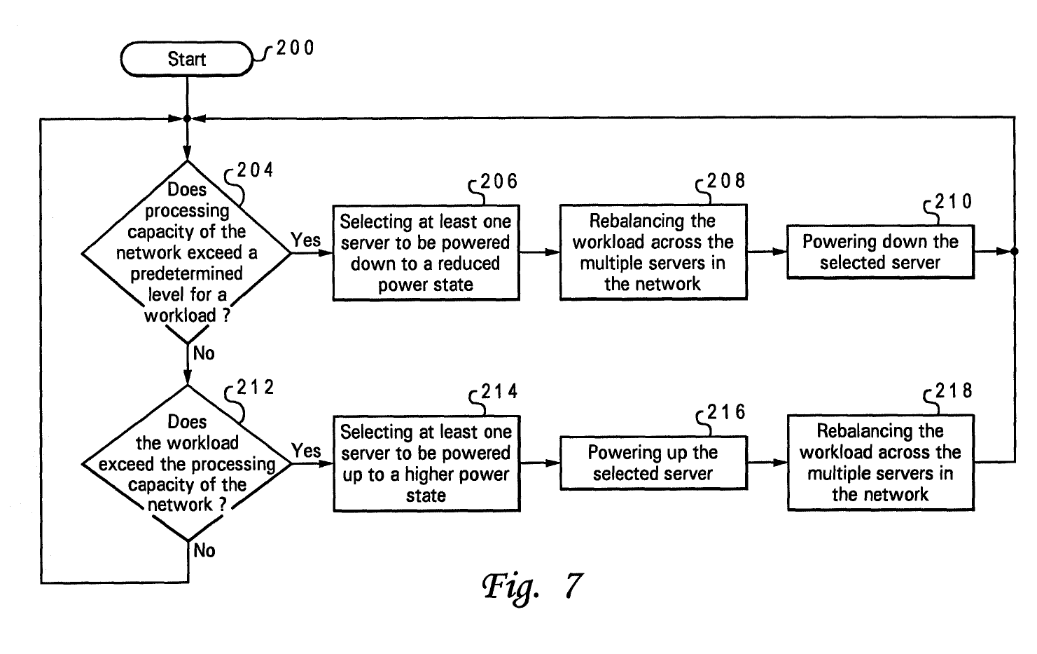

Referring now to FIG. 7, there is depicted a high-level logic flowchart depicting a method of power management. A first preferred embodiment of the present invention can implement the method utilizing resource manager 18, which includes power regulator 26, for controlling power usage in servers 20a-20n, workload manager (WLM) 24, and dispatcher 22 for dynamically distributing the tasks over servers 20a-20n. A second preferred embodiment of the present invention utilizes a resource manager that includes dispatcher 32, ISS 54, and power manager 56 to manage power usage in servers 20a-20n. These components can be implemented in hardware, software and/or firmware as will be appreciated by those skilled in the art.

In the following method, all rebalancing functions are performed by WLM 24 and dispatcher 22 in the first preferred embodiment (FIG. 2) and dispatcher 32 in the second preferred embodiment (FIG. 4). All determinations, selection, and powering functions employ power regulator 26 in the first preferred embodiment and power manager 56 and ISS 54 in the second preferred embodiment.

As illustrated in FIG. 7, the process begins at block 200, and enters a workload analysis loop, including blocks 204, 206, 208, and 210. At block 204, a determination is made of whether or not the aggregate processing capacity of servers 20a-20n exceeds a current workload. The current workload is determined utilizing server performance metrics (e.g., processor utilization and I/O utilization) and compared to the current processing capacity of servers 20a-20n.

If the processing capacity of servers 20a-20n exceeds the current workload, the process continues to block 206, which depicts the selection of at least a server to be powered down to a reduced power state. The total tasks on servers 20a-20n are rebalanced across the remaining servers, as depicted at block 208. As illustrated in block 210, the selected server(s) is powered down to a reduced power state. Finally, the process returns from block 210 to block 204.

As depicted at block 212, a determination is made of whether or not the workload exceeds the processing capacity of servers 20a-20n. If the workload exceeds the processing capacity of servers 20a-20n, at least a server is selected to be powered up to a higher power state, as illustrated in block 214. At least the selected server(s) is powered up, as depicted in block 216, and the tasks is rebalanced over servers 20a-20n. The process returns from block 218 to block 204, as illustrated.

The method of power management of the present invention implements a resource manager coupled to a group of servers. The resource manager analyzes the balance of tasks of the group of servers utilizing a set of performance metrics. If the processing capacity of the group of higher power servers exceeds current workload, at least a server in the group is selected to be powered down to a reduced power state. The tasks on the selected server are rebalanced over the remaining higher power servers. However, if the power manager determines that the workload exceeds the processing capacity of the group of servers, at least a server is powered up to a higher power state, and the tasks are rebalanced over the group of servers.

While the invention has been particularly shown and described with reference to a preferred embodiment, it will be understood by those skilled in the art that various changes in form and detail may be made therein without departing from the spirit and scope of the invention.

What is claimed is:

1. A method for power management in a distributed system including a plurality of servers, said method comprising:
determining whether or not processing capacity of said system exceeds a current workload associated with a plurality of tasks;
in response to determining said processing capacity of said system exceeds said workload, selecting at least one of said plurality of servers to be powered down to a reduced power state;
rebalancing said tasks across said plurality of servers; and
powering down said at least one selected server to a reduced power state.

2. The method according to claim 1, further including:
determining whether or not said workload exceeds said processing capacity of said system; and
in response to determining said workload exceeds said processing capacity of said system, powering up at least one of said plurality of servers to a higher power state.

3. The method according to claim 2, further comprising:
rebalancing said tasks across said plurality of servers.

4. A resource manager, comprising:
a dispatcher for receiving a plurality of tasks and relaying said tasks to a distributed system;
a workload manager (WLM) that balances said tasks on said system; and
a power regulator that determines whether or not processing capacity of a system exceeds a current workload and responsive to determining said processing capacity of said network exceeds said current workload, said power regulator selects and powers down at least one of said plurality of servers to a reduced power state.

5. The resource manager of claim 4, said power regulator including:
means for determining whether or not said current workload exceeds said processing capacity of said system; and
means, responsive to determining said current workload exceeds said processing capacity of said system, for powering up at least one of said plurality of servers to a higher power state.

7. A system, comprising:
a resource manager in accordance with claim 4; and
a plurality of servers coupled to the resource manager for processing said current workload associated with said plurality of tasks.

8. A resource manager, comprising:
an interactive session support (ISS) that determines whether or not processing capacity of a network exceeds a current workload associated with a plurality of tasks;
a power manager that selects and powers down at least one of said plurality of servers down to a reduced power state responsive to said ISS determining said processing capacity of said network exceeds said current workload associated with said plurality of tasks;
a dispatcher that balances said tasks across said plurality of servers; and
a switching logic controlled by said dispatcher to balance said tasks.

9. The resource manager of claim 8, said interactive session support (ISS) further including:
means for determining whether or not said current workload exceeds said processing capacity of said network.

10. The resource manager of claim 8, said power manager comprising:
means for powering up at least one of said predetermined plurality of servers to a higher power state, responsive to said interactive session support (ISS) determining said current workload exceeds said processing capacity of said system.

11. A system comprising:
a resource manager in accordance with claim 8; and
a plurality of servers for processing said current workload associated with said plurality of tasks.

12. A computer program product comprising:
a computer-usable medium;
a control program encoded within said computer-usable medium for controlling a system including a plurality of servers for processing a workload associated with a plurality of tasks, said control program including:
instructions for determining whether or not processing capacity of said system exceeds said workload;
instructions, responsive to determining said processing capacity of said network exceeds said workload, for selecting at least one of said plurality of servers to be powered down to a reduced power state;
instructions for rebalancing said tasks across said plurality of servers; and
instructions for powering down said at least one selected server to a reduced power state.

13. The computer program product according to claim 12, said control program further including:
instructions for determining whether or not said workload exceeds said processing capacity of said system; and
instructions responsive to determining said workload exceeds said processing capacity of said system, for powering up at least one of said plurality of servers to a higher power state.

14. The computer program product according to claim 13, said control program further comprising:
instructions for rebalancing said workload across said plurality of servers.
